(19) United States
(12) Patent Application Publication
(10) Pub. No.: US 2008/0220679 A1
(43) Pub. Date: Sep. 11, 2008

(54) Narrow cavity batt with flange

(76) Inventor: Clarke Berdan, Granville, OH (US)

Correspondence Address: OWENS CORNING, 2790 COLUMBUS ROAD, GRANVILLE, OH, 43023, US

(21) Appl. No.: 11/714,038

(22) Filed: Mar. 5, 2007

(51) Int. Cl. B32B 17/02; B29C 59/00; B32B 3/00; E04B 1/74

(52) U.S. Cl. 442/180; 264/122; 442/59; 52/404.1

(57) ABSTRACT

An insulation product includes an elongated batt of fibrous insulation material having a first major face and a first installation end. A facing covers the first major face. The facing includes a mounting flange extending beyond the first installation end of the elongated batt of fibrous insulation material. A method of producing the insulation product includes the steps covering a major face of an elongated batt of fibrous insulation material with a facing and making a cut line through the elongated batt of fibrous insulation material so as to provide the elongated batt of fibrous insulation material with a first installation end and a removable discard strip adjacent the first installation end.

### CROSS-REFERENCE TO RELATED APPLICATIONS

This patent application is related to U.S. patent application Ser. No. ______ filed ______, entitled “Method of Attenuating Sound Transmitted Through a Building Structure” by Clarke Berdan II, Harry A. Alter, Agustin R. Hernandez, Kevin M. Herreman and Richard D. Godfrey which is hereby incorporated by reference in its entirety.

### TECHNICAL FIELD AND INDUSTRIAL APPLICABILITY OF THE INVENTION

This invention relates to fibrous insulation products of a type suitable for insulating buildings. More specifically, this invention pertains to insulation products having a facing with a projecting flange to aid in mounting the insulation product.

### BACKGROUND OF THE INVENTION

Fibrous insulation products for insulating buildings and more particularly, the cavities between wall studs, floor joists and ceiling joists are well known in the art. Insulation in exterior walls primarily functions as thermal insulation to isolate the interior space of a building from ambient temperature extremes. In contrast, interior walls are often insulated to provide sound damping and attenuation. Insulation products known in the art to be useful for these purposes are disclosed in, for example, U.S. Pat. Nos. 4,702,046, 5,983,586, 6,128,884, 6,191,057, 6,484,463 and 6,901,711.

Generally, the insulation products of the prior art are cut to a size greater than the wall cavity into which they are to be inserted. The products are then compressed and forced into the cavity to provide a friction fit that holds the insulation product in place until the cavity is closed with a sheathing or finishing material such as drywall.

The present invention relates to an insulation product incorporating a facing with a projecting mounting flange that may be used to fasten and hold the insulation product in place in a cavity until that cavity is closed with a finishing material.

### SUMMARY OF THE INVENTION

In accordance with the purposes of the present invention as described herein, an insulation product is provided comprising an elongated batt of fibrous insulation material having a first major face and a first installation end. A facing covers the first major face. The facing includes a mounting flange that extends beyond the first installation end of the elongated batt of fibrous insulation material. The elongated batt of fibrous insulation material may further include a discard strip connected to the mounting flange and separated from the installation end by a cut line.

More specifically describing the invention the elongated batt of fibrous insulation material is made from a material selected from a group consisting of glass fibers, mineral fibers, organic fibers and mixtures thereof. The elongated batt of fibrous insulation material has a density within a range of about 0.3 to about 1.0 pounds per cubic foot (pcf). Further, the elongated batt of fibrous insulation material includes straight fibers, irregular fibers and mixtures thereof. The batt may include typically 100% mineral fibers and of about 3 to about 7 weight percent organic binder.

In accordance with another aspect of the present invention, a method of producing an insulation product is provided. That method comprises the steps of covering the major face of an elongated batt of fibrous insulation material with a facing and providing that facing with a mounting flange extending beyond a first installation end of the elongated batt of fibrous insulation material. Stated another way, the method of producing an insulation batt comprises the steps of covering the major face of an elongated batt of fibrous insulation material with a facing and making a cut running through the elongated batt of fibrous insulation material so as to provide the elongated batt of fibrous insulation material with a first installation end and a removable discard strip adjacent that first installation end.

In accordance with still another aspect of the present invention, a method of installing an insulation product in a wall cavity is provided. The wall cavity is defined by framing members including a top plate, a bottom plate and two wall studs. The insulation product includes an elongated batt of fibrous insulation material and a facing including a mounting flange that extends beyond a first installation end of the elongated batt. The method comprises the steps of securing the mounting flange to the top plate and inserting the insulation product in the wall cavity between the framing members. Still further, the method may include the step of removing a discard strip of the elongated batt of fibrous insulation material so as to expose the mounting flange before securing the mounting flange to the top plate. In addition, the method includes the step of compressing the insulation product between opposing sections of finishing materials used to close the wall cavity.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### DESCRIPTION OF THE DRAWINGS

The accompanying drawings incorporated in and forming a part of this specification, illustrate several aspects of the present invention, and together with the description serve to explain certain principles of the invention. In the drawings:

FIG. 1 is a perspective view of the insulation product of the present invention;

FIG. 2a is a side elevational view of the insulation product with the discard strip in place.

FIG. 2b is a detailed side elevational view corresponding to FIG. 2a but showing the discard strip removed to expose the mounting flange and first installation end of the insulation product;

FIG. 3a is a rear plan view showing the securing of the mounting flange of the facing to the top plate forming the upper end of a wall cavity;

FIG. 3b is a side elevational view showing the positioning of the insulation product in the wall cavity following attachment with the mounting flange;

FIG. 3c is a side elevational view demonstrating the compression of the insulation product between the finishing materials that close the cavity;

FIG. 4a is a schematical illustration of the making of the insulation product; and

FIG. 4b is a detailed schematical side elevational view illustrating the making of the cut line, the first installation end and the discard strip in a single manufacturing step.

Reference is now made in detail to the present embodiments of the invention, examples of which are illustrated in the accompanying drawings.

### DETAILED DESCRIPTION OF THE PREFERRED EMBODIMENTS OF THE INVENTION

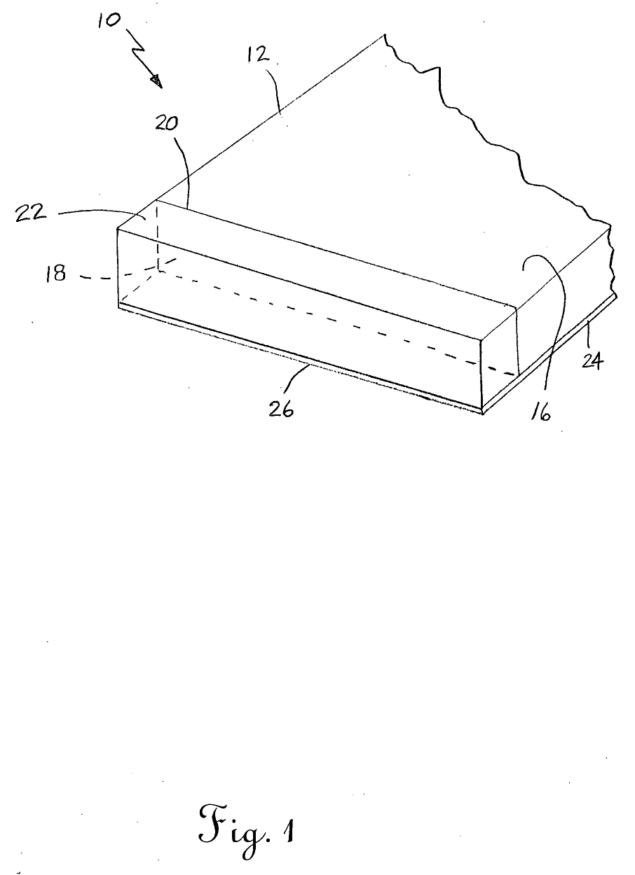

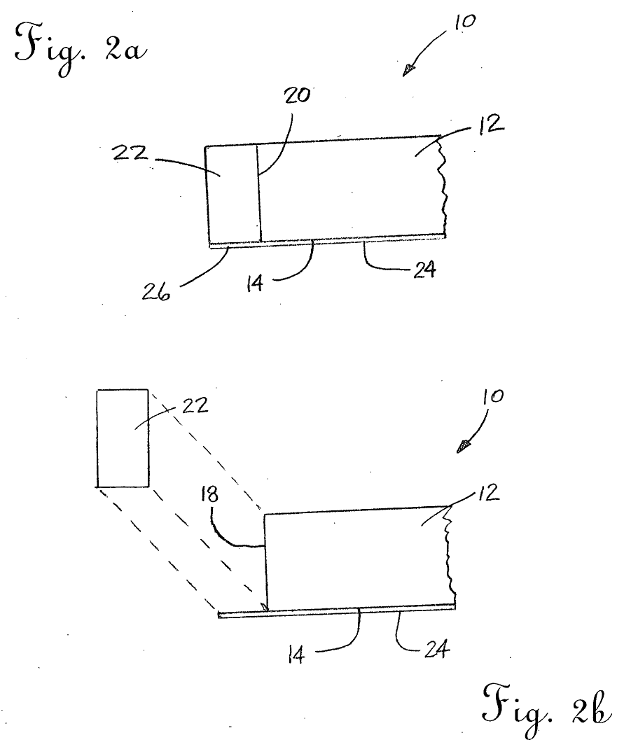

Reference is now made to FIGS. 1, 2a, and 2b illustrating the insulation product 10 of the present invention. The insulation product 10 includes an elongated batt 12 of fibrous insulation material having a first major face 14, a second major face 16, a first installation end 18, a cut line 20 and a discard strip 22. A facing 24 covers the first major face 14. The facing 24 may be secured to the first major face 14 of the elongated batt 12 by any appropriate means known in the art including but not limited to an appropriate bonding layer or an adhesive.

The fibrous insulation material of the elongated batt 12 may be made from mineral fibers, organic fibers and mixtures thereof. The mineral fibers most typically comprise glass fibers although other mineral fibers such as rock, slag or basalt may be utilized.

The organic fibers typically include polymeric material from which fibers of suitable length, strength, durability and insulation characteristics can be formed. Suitable polymer materials for making the polymer fibers include, but are not limited to polyolefins and polyesters. More specifically, suitable polymer materials include but are not limited to polyethylene terephthalate, polypropylene, polyphenylene sulfide, nylon, polycarbonate, polystyrene and polyamide.

Typically the elongated batt 12 of fibrous insulation material has a density within a range of from about 0.3 to about 1.0 pounds per cubic foot (pcf) although densities outside this range may also be utilized. The fibers utilized in the insulation material may include straight fibers, irregular fibers and mixtures thereof. The elongated batt 12 may be a conformable body such as described in U.S. Pat. No. 6,128,884 and may be binderless. Alternatively, the elongated batt 12 may incorporate some binder material in fiber, film, or powder form. Typically, between about 3 and about 7 weight percent of organic binder is provided.

The facing 24 may be made from any appropriate material known in the art to be useful as a facing for an insulation product to be used in insulating a building. Such material includes but is not limited to kraft paper, metal foils, polymer films and even dual layer facings comprising a co-extruded polymer film with a barrier layer and a bonding layer of the type described in, for example, U.S. Pat. No. 6,191,057.

The installation of the insulation product 10 in the cavity of a wall will now be described in detail. More specifically, reference is now made to FIGS. 2a-2b illustrating in detail the first installation end 18, cut line 20 and discard strip 22 of the elongated batt 12. As clearly shown in FIG. 2a the cut line 20 extends completely through the fibrous insulation material of the elongated batt 12 but does not sever the facing 24. The installer firmly grasps the discard strip 22 and pulls the strip from the facing 24 thereby exposing the first installation end 18 of the elongated batt 12 and the mounting flange 26 of the facing 24 (see particularly FIG. 2b). As clearly illustrated, the mounting flange 26 projects beyond the first installation end 18 of the elongated batt 12 thereby providing a means for stapling, adhering, tacking or otherwise securing the insulation product 10 to the framework around a wall cavity.

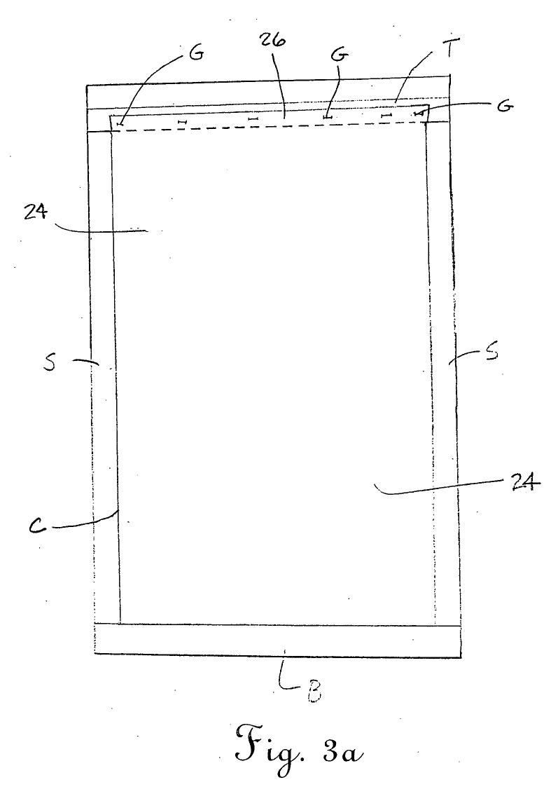

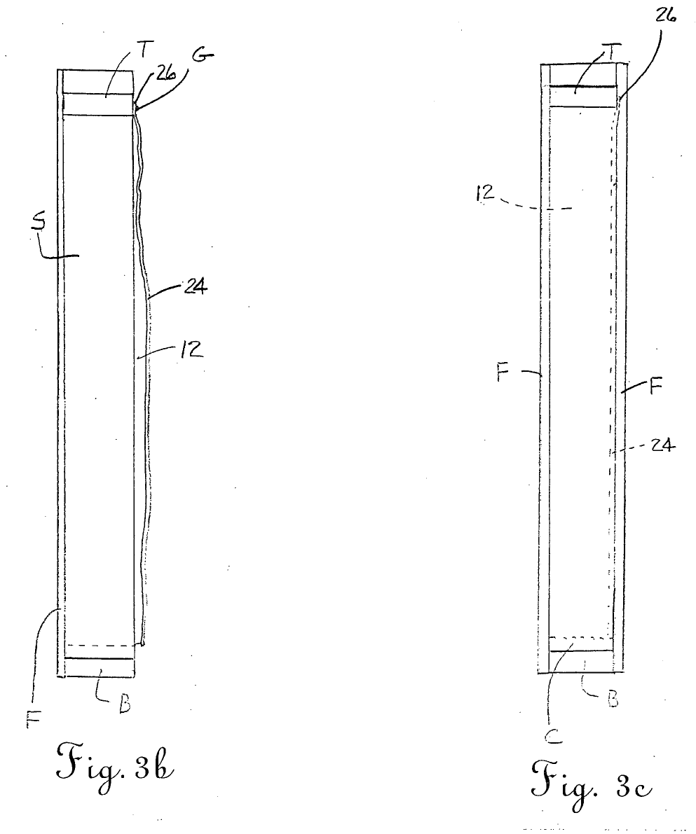

Reference is now made to FIGS. 3a, 3b and 3c clearly illustrating the actual installation of the insulation product 10 into a wall cavity C. More specifically, as illustrated the wall cavity C is defined by framing including a top plate T, a bottom plate B and two studs S extending between the top plate and the bottom plate. The insulation product 10 is inserted into the wall cavity C while aligning the mounting flange 2b over the side of the top plate T with the installation end 18 along the bottom of the top plate. Staples, tacks or other fasteners are then driven through the mounting flange 26 into the top plate T in order to secure the mounting flange 26 in position (note staples G in FIGS. 3a and 3b). Any remaining portion of the insulation product 10 including the elongated batt 12 is pushed into the wall cavity C. As best illustrated in FIG. 3b, it should be appreciated that the insulation product 10 may have a thickness T that is greater than the depth D of the wall cavity C as defined by the thickness of the plates T, B and studs S. It is significant to note that the insulation product 10 may have a width and/or a length that is less than the width or the length of the wall cavity C. In such an instance, the securing of the mounting flange 26 to the top plate T ensures that the insulation product 10 is held in proper position in the wall cavity C until that cavity may be fully closed.

Next, as illustrated in FIG. 3c, the wall cavity C is closed using finishing materials F. Typically the finishing materials F comprise some form of sheathing such as paneling, dry wall or gypsum board. More specifically, a first section of finishing material F is secured over the top plate T, bottom plate B and studs S to close one side of the wall cavity C engaging the second major face 16 of the batt 12. A second section of finishing material F is then secured to the opposite side of the top plate T, bottom plate B and studs S in engagement with the facing 24 in order to fully close the wall cavity C. During this process, the insulation product 10 may be compressed between the two sheets of finishing material F. As a result of this compression and the resilient nature of the insulation product 10, a force is exerted against the finishing material F. This force F effectively dampens and attenuates sound that would otherwise be transmitted through the wall.

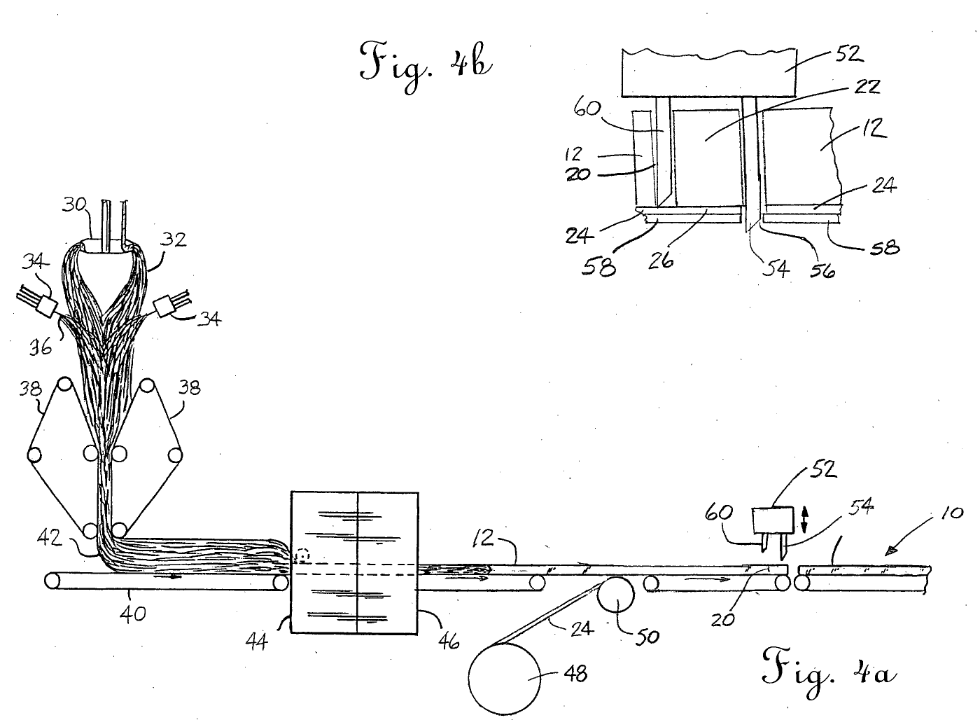

The insulation product 10 may be produced in the manner illustrated in FIGS. 4a and 4b. More specifically, the spinner 30 produces a veil 32 of glass fibers. Polymer fiber dyes 34 produce arrays 36 of polymer fibers and direct polymer fibers into contact with the glass fibers to integrate the polymer fibers with the glass fibers. Direct forming conveyors 38 are provided with an air evacuation apparatus to assist with removing air from the integrated glass and polymer fibers. The integrated glass fibers and polymer fibers are gathered by converging direct forming conveyors 38 and collected on a conveyor 40 as a direct formed pact 42.

The direct-formed pact 42 is moved through a product-shaping oven 44 where hot gases are blown through the pact to slightly soften the polymer fibers so that they bond to the glass fibers to form the elongated batt 12. Preferably, the pact 42 is under vertical compression during the product shaping process so that the product thickness is defined. Immediately following the oven 44 is the cooling section 46 where the formation of the batt 12 is completed.

The facing 24 is secured to the elongated batt 12 downstream from the cooling section 46. More specifically, the facing 24 is fed from a roll 48 and allowed to cover the first major face 14 of the elongated batt 12. A heated pressing roll 50 activates a bonding layer or adhesive and provides the necessary pressure to secure the facing 24 to the elongated batt 12. A predetermined length of insulation product 10 is then fed past the chopper 52. The chopper 52 includes dual blades. When activated, the first or longer blade 54 cuts through both the elongated batt 12 and the facing 24 extending downwardly through a slit 56 in a backing plate 58 (see FIG. 4b). Simultaneously, the second and shorter blade 60 cuts through the elongated batt 12 forming the cut line 20 that separates the first installation end 18 of the elongated batt 12 from the discard strip 22. The facing 24 below the shorter blade 60 remains uncut and intact. The mounting flange 26 is the portion of the facing 24 provided beneath the discard strip 22.

The foregoing description of the preferred embodiments of the present invention have been presented for purposes of illustration and description. It is not intended to be exhaustive or to limit the invention to the precise form disclosed. Obvious modifications or variations are possible in light of the above teachings. For example, the facing 24 could be secured to the elongated batt 12 after the elongated batt has been cut to the desired length. In this method the facing 24 could be slightly longer than the elongated batt 12. The facing 24 would then be secured to the batt 12 so that the mounting flange 26 projects beyond the first installation end 18 of the elongated batt 12. Further, the mounting flange 26 could be secured to the bottom side of the top plate T rather than the side as illustrated in FIG. 3a if desired.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1.) An insulation product, comprising:
an elongated batt of fibrous insulation material having a first major face and a first installation end; and
a facing covering said first major face, said facing including a mounting flange extending beyond said first installation end of said elongated batt of fibrous insulation material.

2.) The insulation product of claim 1, wherein said elongated batt of fibrous insulation material further includes a discard strip connected to said mounting flange and separated from said first installation end by a cut line.

3.) The insulation product of claim 1, wherein said elongated batt of fibrous insulation material is made from a material selected from a group consisting of glass fibers, mineral fibers, organic fibers and mixtures thereof.

4.) The insulation product of claim 3, wherein said elongated batt of fibrous insulation material has a density within a range of from about 0.3 to about 1.0 pounds per cubic foot (pcf).

5.) The insulation product of claim 4, wherein said elongated batt of fibrous insulation material includes straight fibers, irregular fibers and mixtures thereof.

6.) The insulation product of claim 5, wherein said elongated batt of fibrous insulation material includes between about 3 to about 7 weight percent organic binder.

7.) The insulation product of claim 1 wherein said facing is made from a material selected from a group consisting of kraft paper, metal foil, polymer fiber and dual layer facing having a co-extruded polymer film and a barrier layer.

8.) A method of producing an insulation product, comprising:
covering a major face of an elongated batt of fibrous insulation material with a facing; and
providing said facing with a mounting flange extending beyond a first installation end of said elongated batt of fibrous insulation material.

9.) A method of producing an insulation product, comprising:
covering a major face of an elongated batt of fibrous insulation material with a facing;
making a cut line through said elongated batt of fibrous insulation material so as to provide said elongated batt of fibrous insulation material with a first installation end and a removable discard strip adjacent said first installation end.

10.) A method of installing an insulation product in a wall cavity defined by framing members including a top plate, a bottom plate and two wall studs wherein said insulation product includes an elongated batt of fibrous insulation material and a facing including a mounting flange extending beyond a first installation end of said elongated batt of fibrous insulation material, said method comprising:
securing said mounting flange to said top plate; and
inserting said insulation product in said wall cavity between said framing members.

11.) The method of claim 10, including:
removing a discard strip of said elongated batt of fibrous insulation material so as to expose said mounting flange before securing said mounting flange to said top plate.

12.) The method of claim 11 including compressing said insulation product between opposing sections of finishing materials used to close said wall cavity.

13.) The method of claim 10, including compressing said insulation product between opposing sections of finishing materials used to close said wall cavity.

14.) An insulation system comprising:
at least one interior wall cavity, wherein said cavity further comprises at least one elongated batt of fibrous insulation material having a first major face and a first installation end; and a facing covering said first major face, said facing including a mounting flange extending beyond said first installation end of said elongated batt of fibrous insulation material.

15.) The insulation system of claim 14, wherein said wall cavity is defined by framing including a top plate, a bottom plate, and a first stud and a second stud, wherein said first stud and second stud extend between said top plate and said bottom plate.

16.) The insulation system of claim 15, wherein said insulation material is on the side of said wall cavity

17.) The insulation system of claim 16, wherein said mounting flange of said insulation product resides over the side of said top plate and said first installation end resides along the bottom of said top plate.

18.) The insulation system of claim 17, wherein said mounting flange is secured to said top plate.

19.) The insulation system of claim 18, wherein any remaining portion of said insulation product is pushed into said wall cavity.

20.) The insulation system of claim 14, wherein said insulation product has a thickness T that is greater than the depth D of said wall cavity as defined by the thickness of said top plate, said bottom plate and said studs.
